(19) United States
(12) Patent Application Publication
(10) Pub. No.: US 2003/0094256 A1
(43) Pub. Date: May 22, 2003

(54) Shoe roll

(75) Inventor: Helmut Heinzmann, Bohmenkirch (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/300,795

(22) Filed: Nov. 21, 2002

(30) Foreign Application Priority Data
Nov. 22, 2001 (DE) 101 57 222.0

(51) Int. Cl. D21F 3/02; B30B 15/04

(52) U.S. Cl. 162/358.3; 162/361; 162/204; 162/205; 492/7; 492/20; 100/38; 100/153; 100/160; 100/155 R

(57) ABSTRACT

Shoe roll for dewatering or calendering a moving fibrous web. The shoe roll includes a flexible, replaceable press cover having two end regions and at least one end supporting disc. At least one of the two end regions have reinforcing inlays and are releasably coupled to the at least one end supporting disc. A quick-acting closure, located between an inner wall of the at least one end region and the at least one end supporting disc, includes a radially pressing element structured to exert a pressing force and to simultaneously seal an interior of the shoe roll from an external environment. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 101 57 222.0 filed Nov. 22, 2001, the disclosure of which is expressly incorporated by reference herein in its entirety.

### BACKGROUND OF THE INVENTION

1. Field of the Invention

The present invention relates to a shoe roll for dewatering or calendering a moving fibrous web, in particular paper or board web, within a machine for producing and/or finishing the fibrous web. The shoe roll includes a flexible, replaceable press cover which, at least in one of its end regions, has reinforcing inlays and, at these end regions, the press cover can be fixed in a sealing manner to end supporting discs and released again in the event of replacement of the press cover.

2. Discussion of Background Information

As is known, such a shoe roll, together with an opposing roll, forms a press nip that is extended in the web running direction.

The flexible press cover is fixed at each roll end to a rotatable end supporting disc. Through the interior of the press roll there extends a stationary supporting element, on which the supporting discs are mounted and which supports a hydrostatic or hydrodynamic press shoe which can be moved radially and is used to press the press cover against the opposing roll. Therefore, this roll is also referred to as a shoe press roll.

The interior of the roll is under pressure, in order to improve its running behavior.

In order to lubricate the contact surface between press shoe and the rotating press cover, oil is generally used, which, of course, must not get into the surroundings.

The flexible press cover is formed of rubber or plastic, preferably polyurethane.

A shoe roll of this type is disclosed by, e.g., German Patent Application No. DE 196 45 407 A1.

To support the axial end region of the roll cover, the end supporting disc (also referred to as a side plate) is constructed as a wheel rim with an air-filled tube. In this case, the wheel rim is mounted such that it can rotate on the stationary supporting element, while the tube is connected to the roll cover. In this way, radial support for the end regions of the roll cover is achieved with radial compliance.

There is often reinforcement in the press cover formed with laid filaments. Recently, the end regions of the press cover have additionally been reinforced, in order in this way to achieve a better, more stable attachment area for the assembly and disassembly of the press cover.

A reinforcing inlay of this type is described in, e.g., German Patent Application No. DE 10138526.9, published subsequently.

The machines for producing and finishing the fibrous web are used in continuous operation over relatively long time periods.

Due to occurring wear, the fabric-like press cover and other machine parts of such a shoe roll have to be replaced regularly, during the planned, short down times. The replacement of the press cover frequently determines the downtime of the paper machine, as a result of the complicated assembly work.

For example, the roll cover to be replaced has to be released from the end wall. The new roll cover then has to be fixed to the end supporting discs in such a way that the required sealing of the interior of the press roll with respect to the surroundings is ensured.

However, the aforementioned operations are also required in the cases where access has to be gained to the interior of the roll for service purposes.

The respective manner of assembly and disassembly is therefore critical for the down times which, as already mentioned, should be as short as possible.

In a press roll of the type mentioned at the beginning and disclosed by, e.g., German Patent Application No. DE 35 01 635 C2, a respective end region of the press cover is pressed against the outer end of the relevant end wall by a clamping flange, for which it is necessary for the end region to be bent over radially inward. In order to make this possible, the end region is provided with a large number of cuts and remaining tabs.

Corresponding projections are provided in the end supporting disc which, when the press cover is assembled, engage in its aforesaid cuts at the edge.

The production expenditure for fixing elements of this type is enormously high and would not be at all feasible in the case of further reinforced edge regions of the press cover.

In addition, solutions are known in which the aforementioned tabs have to be screwed individually to the end discs. For this purpose, a large number of screws are needed, in order to provide the press cover with sufficient retention and to seal off the interior of the roll with respect to the surroundings, in order firstly to prevent a leakage of oil and secondly to maintain a specific internal pressure.

It is possible to gather from, e.g., German Patent Application No. DE 29702362 that the cylindrical press cover end region, for the purpose of being clamped firmly, is clamped in between an inner spreading ring which can be spread, i.e., having an enlargeable diameter, and an outer ring.

The disadvantage here is that although the production operation for the preparation of the roll end regions and the fitting takes less time than in the case of the solutions mentioned above, the outer ring which is present is disruptive and also makes assembly and disassembly cumbersome again.

### SUMMARY OF THE INVENTION

The present invention provides a shoe roll of the type mentioned at the beginning in which the connection of a press cover reinforced in its end regions to the end supporting disc can be carried out more quickly than previous with simple and reliably acting elements in order to ensure reliable sealing of the interior of the roll, and without substantially changing the outer dimensions of the roll.

According to the invention, a quick-acting closure is provided which is configured in such a way that an element which presses radially, and whose pressing force can be varied, is arranged between the interior of the press cover end region and the end supporting disc and is simultaneously suitable also for sealing off the interior of the shoe press roll in a gas tight manner with respect to the surroundings. The device according to the invention is located in the interior of the press cover. Moreover, external clamping devices can be avoided. As a result, the diameter of the shoe press roll in the edge regions is substantially of the same size as in the central part. The advantage here is that the shoe roll does not have to be constructed substantially wider than the opposing roll in order to avoid collision with clamping elements. A further advantage is that the radially pressing element is radially more compliant, and therefore, at least to some extent, cooperates in the concave deformation of the press cover in the press nip between opposing roll and concave shoe, even in the edge region. The deformation differences in the press cover between edge and center are thereby minimized, and the running time of the cover is extended.

In this way, the instant invention provides an operationally reliable connection, which, as stated, acts extremely quickly, between the press cover end and roll.

In an exemplary embodiment, the radially pressing element is at least one inflatable pressure hose which extends in the circumferential direction in a holding groove in the end disc, firmly clamping the press cover end region in a sealing manner when pressure is applied to it and loosening or releasing the press cover end region when the pressure is reduced.

During the operation of the shoe press, the hose is always under pressure.

One expedient embodiment of the invention is that the end of the end supporting disc which holds the pressure hose is covered by a hose strap.

Furthermore, it is expedient if two pressure hoses arranged beside each other in the axial direction are provided around the end disc.

As a result, the arrangement acts like a double seal.

The outer hose, facing the roll end and arranged in the aforesaid holding groove, is in this case located with its outer surface between the hose strap and the holding groove of the supporting disc, whereas the inner hose (which points in the axial direction towards the roll center) is located with its outer surface between the outside of the hose strap and the inner wall of the press cover.

As stated, the aforesaid hose strap covers one hose and, therefore, also possible colliding edges during the assembly operation of the press cover.

The hose strap has a first region with a smaller diameter and a second region with a larger diameter. The first region surrounds the end of the supporting disc in the interior of the shoe press roll, and the second region surrounds or covers the pressure hose located in the holding groove. As a result, during the assembly of the cover, the hose strap acts like a “shoe horn” and therefore makes it possible to pull the press cover axially on or off more easily.

This advantage is effective particularly when the second hose, pointing towards the roll center, is not provided.

It is advantageous if the aforesaid hose strap is connected at one end to the supporting disc. Alternatively, however, it is also possible that it is only pushed on, shrunk on or else firmly connected to one or both pressure hoses. As a result, the outlay on assembly can be reduced and also the retaining power of the hose strap can be improved.

An expedient embodiment of the inner surface of the hose strap and/or of the inner surface of the press cover end region and the outer surface of one pressure hose or both pressure hoses provided can include each of them being provided with machined profiles. The profiling of the pair includes that the hose strap/pressure hose or the pair engage with the press cover/pressure hose when pressure is applied, so that in addition to the force fit there is also a form fit.

Grooves or flutes with a circular or polygonal cross section, which extend in the circumferential direction and/or transversely with respect to the circumferential direction are conceivable profiling shapes or structures.

According to another exemplary embodiment of the invention, the radially pressing element includes at least one piston-spring unit. This piston-spring unit, which is held in a circumferential recess in the end disc, in the clamping state presses a seal against the inner wall of the end region of the press cover via a seal carrier on which it can act. With this seal, which can be, e.g., a sealing ring which is arranged around the seal carrier, sufficiently good sealing of the interior of the shoe press roll with respect to the surroundings is achieved.

Provision is additionally made for the outwardly open recess to have a widening on each side. The widenings are used to hold a hose in each case which is filled with a pressure medium (for example with air) and which can counteract the spring force. In these widenings or recesses, there is also arranged a part of the piston (piston crown), against which the hoses are supported.

In this case, the arrangement is such that, as opposed to the variant described first, the end region of the press cover can be released from the end supporting disc when the hoses have pressure applied to them.

In order to ensure sufficiently good circularity of the roll, at least three, preferably six, piston-spring units with curved pressing surfaces of the piston or piston crown which are matched to the diameter and the width of the recess in the end disc are arranged in the manner of segments or a star around the base of the recess.

However, it is also conceivable for the pistons of the piston-spring unit to be produced as an at least two-part, cylindrical part with a T-shaped cross section and pressing surfaces matched to the diameter and the width of the recess in the end disc.

The seal carrier pressed against the press cover in the clamped state is provided on its outer circumference with cuts extending radially and transversely with respect to the circumferential direction (running direction of the cover), which may be widened radially when pressed against the press cover end region. The depth of the cuts is less than the depth of the circumferential groove machined into the seal carrier. The seal described above, which can be an O ring or a ring with a square cross section, a sealing pad or the like, is let into this outwardly open groove. The height of the seal is in this case dimensioned to be greater than the depth of the groove which holds it, which achieves the sealing effect.

In a further embodiment, a quick-acting closure is included.

Conventional shoe rolls, that is to say shoe press rolls for achieving a specific dryness content or calendering rolls for achieving a specific smoothness of the fibrous web, can be retrofitted with such a quick-acting closure according to the invention.

Mention should further be made of the fact that the present invention is primarily suitable for roll covers with a reinforced end region, which could not be pulled onto a shoe roll with conventional equipment. Such a reinforced end region is described in, e.g., German Patent Application No. DE 101 38 526.9, published subsequently, of which the entire content is hereby declared to form a constituent part of the description. For the solution according to the invention, it is advantageous if the edge reinforcement is so great that excessive expansion of the cover by the radially pressing element is avoided. The modulus of elasticity of the cover in the circumferential direction should therefore be E≧45 N/mm², preferably E≧70 N/mm², in particular E≧90 N/mm².

A further advantage of the invention relates to the recovery of the cover to be dismantled. While the press covers to be dismantled normally have to be cut out for time reasons, this labor-intensive step is dispensed with. The invention makes it possible to dismantle the press cover safely and in an ordered manner on the assembly side (operator side). In this case, the same device can be used as is used for cover installation.

The present invention is directed to a shoe roll for dewatering or calendering a moving fibrous web. The shoe roll includes a flexible, replaceable press cover having two end regions and at least one end supporting disc. At least one of the two end regions have reinforcing inlays and are releasably coupled to the at least one end supporting disc. A quick-acting closure, located between an inner wall of the at least one end region and the at least one end supporting disc, includes a radially pressing element structured to exert a pressing force and to simultaneously seal an interior of the shoe roll from an external environment.

In accordance with a feature of the invention, the fibrous web can include one of a paper and a board web.

According to another feature of the invention, the pressing force exerted by the radially pressing element can be variable.

The at least one supporting disc can include a circumferential groove and the radially pressing element comprises at least one inflatable pressure hose arranged within the groove. The at least one inflatable pressure hose can be positioned such that inflating the pressure hose firmly clamps the at least one end region in a sealing manner with the at least one supporting disc and deflating the inflatable pressure hose at least one of loosens and releases the end region from the at least one supporting disc. A hose strap is arranged in a region of the at least one supporting disc that holds the inflatable pressure hose. Further, a second pressure hose can be arranged beside the inflatable pressure hose in an axial direction around the at least one supporting disc. The inflatable pressure hose is arranged axially outside of the second pressure hose and is located between an inner surface of the hose strap and the groove, and the second pressure hose is located between an outer surface of the hose strap and an inner wall of the end region. The hose strap can include a first region having a first diameter and a second region having a second diameter, in which the first diameter is smaller than the first diameter, and the first region is arranged to cover an end of the supporting disc and the second region is arranged to cover the inflatable pressure hose. Moreover, the hose strap can be connected to at least one of the at least one supporting disc and at least one of the inflatable pressure hose and the second pressure hose. Still further, the hose strap may be pushed onto the at least one supporting disc, and/or the inflatable pressure hose can form a unit with the press cover. The inner wall of the end region is structured such that, when at least one of the inflatable pressure hose and the second pressure hose is inflated, a form fit occurs between the at least one of the inflatable pressure hose and the second pressure hose and the inner wall as well as a frictional fit.

Further, an inner wall of the end region can be structured such that, when the at least one inflatable pressure hose is inflated, a form fit occurs between the at least one inflatable pressure hose and the inner wall as well as a frictional fit. The at least one inflatable pressure hose may adhere to an inner wall of the end region. Moreover, the at least one inflatable pressure hose can be welded to the inner wall of the said end region.

According to another feature of the present invention, the radially pressing element comprises at least one piston-spring unit including a spring and a piston, and a seal carrier arranged to carry at least one seal between a clamping state, in which the at least one seal is pressed against an inner wall of the end region, and an unclamping state, in which the at least one seal is moved out of contact with the inner wall to release the at least one end region from the at least one supporting disc. The at least one piston-spring unit can be arranged to move the seal carrier between the clamping and unclamping states. The at least one supporting disc may include a circumferential outwardly open recess, and the piston-spring unit is located in the open recess. The open recess has a widening on each side to hold inflatable hoses, which are arranged to counteract a force of the spring, such that, when pressure is applied to the hoses, the at least one end region is loosened or released from the supporting disc. The piston can include an at least two-part, cylindrical part having a T-shaped cross section and pressing surfaces matched to a diameter and a width of the open recess. At least three piston-spring units with curved pressing surfaces matched to the diameter and the width of the open recess can be arranged in the manner of segments around the base of the open recess, and the at least three piston-spring units can be six piston-spring units. The seal carrier can have cuts on an outer circumference that extend radially in a circumferential direction, and the seal carrier may include an outwardly open groove arranged to hold a sealing element. A height dimension of the outwardly open groove may be less than a height of the sealing element.

According to a further feature of the invention, a modulus of elasticity of said cover in a circumferential direction is greater than or equal to 45 N/mm², preferably greater than or equal to 70 N/mm², and in particular, greater than or equal to 90 N/mm².

The present invention is directed to a quick-acting closure for a shoe roll for dewatering or calendering a moving fibrous web that includes a flexible, replaceable press cover having two axial end regions, reinforcing inlays provided in at least one of the two axial end regions, and at least one supporting disc positionable in the at least one end region. The quick-acting closure includes a radially pressing element structured to exert a pressing force and to simultaneously seal an interior of the shoe roll from an external environment. The radially pressing element is located between an inner wall of the at least one end region and the at least one end supporting disc.

According to a feature of the invention, the at least one supporting disc may include a circumferential groove and the radially pressing element comprises at least one inflatable pressure hose arranged within the groove. The at least one inflatable pressure hose can be positioned such that inflating the pressure hose firmly clamps the at least one end region in a sealing manner with the at least one supporting disc and deflating the inflatable pressure hose at least one of loosens and releases the end region from the at least one supporting disc.

In accordance with another feature of the invention, the radially pressing element can include at least one piston-spring unit including a spring and a piston, and a seal carrier arranged to carry at least one seal between a clamping state, in which the at least one seal is pressed against an inner wall of the end region, and an unclamping state, in which the at least one seal is moved out of contact with the inner wall to release the at least one end region from the at least one supporting disc.

Moreover, the at least one supporting disc includes a circumferential outwardly open recess, and the piston-spring unit is located in the open recess. The open recess has a widening on each side to hold inflatable hoses, which are arranged to counteract a force of the spring, such that, when pressure is applied to the hoses, the at least one end region is loosened or released from the supporting disc. At least three piston-spring units with curved pressing surfaces matched to the diameter and the width of the open recess are arranged in the manner of segments around the base of the open recess, such that the seal carrier has cuts on an outer circumference that extend radially in a circumferential direction, and the seal carrier comprises an outwardly open groove arranged to hold a sealing element. A height dimension of the outwardly open groove is less than a height of the sealing element.

The present invention is directed to a process of connecting and disconnecting the press cover of a shoe roll the process includes axially moving at least one end of the at least one press cover onto the at least one supporting disc, such that the at least one supporting disc radially opens the at least one end.

In accordance with a feature of the invention, the at least one supporting disc may include a circumferential groove and the radially pressing element may include at least one inflatable pressure hose, and process can further include, prior to axially moving at least one end onto the at least one supporting disc, placing the at least one inflatable pressure hose into the groove, and, after the at least one end is moved onto the at least one supporting disc, inflating the at least one inflatable pressure hose against an inner surface of the at least one press cover. Further, after the at least one inflatable pressure hose is placed in the groove, but prior to axially moving the at least one end onto the at least one supporting disc, the process may further include placing a belt over the at least one inflatable pressure hose, such that the belt acts as a shoe horn to assist in radially opening the at least one end. Moreover, after the at least one inflatable pressure hose is placed in the groove, but prior to axially moving the at least one end onto the at least one supporting disc, and the process can further include placing a belt over the at least one inflatable pressure hose, positioning a second inflatable pressure hose adjacent the first inflatable pressure hose and over the belt, and inflating the second inflatable pressure hose to further clamp the at least one end onto the at least one supporting disc. The second inflatable pressure hose can be positioned axially inside of the at least one inflatable pressure hose. Still further, the at least one inflatable pressure hose and an inner surface of the at least one end can be provided with inter-meshable ridges, such that, after inflating the at least one inflatable pressure hose, the inter-meshable ridges intermesh.

According to another feature of the instant invention, the at least one supporting disc may include a circumferential groove and the radially pressing element can include at least one inflatable pressure hose, and process can further include, prior to axially moving at least one end onto the at least one supporting disc, attaching the at least one inflatable pressure hose to the at least one end, such that, after the at least one end is moved onto the at least one supporting disc, the at least one inflatable pressure hose is positioned the groove, and, after the at least one end is moved onto the at least one supporting disc, inflating the at least one inflatable pressure hose to clamp the at least one end to the at least one press cover. The at least one inflatable pressure hose can be attached by one of form fitting, welding, adhering.

According to still another feature, the at least one supporting disc includes an inclined leading edge formed to assist in radially opening the at least one end.

In accordance with still yet another feature of the present invention, the connecting and disconnecting process is performed using the same assembly devices at each end of the shoe roll.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, by reference to the noted plurality of drawings by way of non-limiting examples of preferred embodiments of the present invention, in which like reference numerals represent similar parts throughout the several views of the drawings, and wherein:

FIGS. 1a-1d illustrate partial longitudinal sections of exemplary embodiments of a quick-acting connection (quick-acting closure) according to the invention between a press cover of the shoe press roll and its end disc;

FIG. 2 illustrates a partial longitudinal section of a further embodiment of the quick-acting connection depicted in FIG. 1a;

FIG. 3 illustrates a partial longitudinal section of another embodiment of the quick-acting closure according to the invention;

FIG. 4 illustrates an end view of the embodiment depicted in FIG. 3; and

FIG. 5 illustrates a detailed view of the connection between the hose and the inner wall or hose strap.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

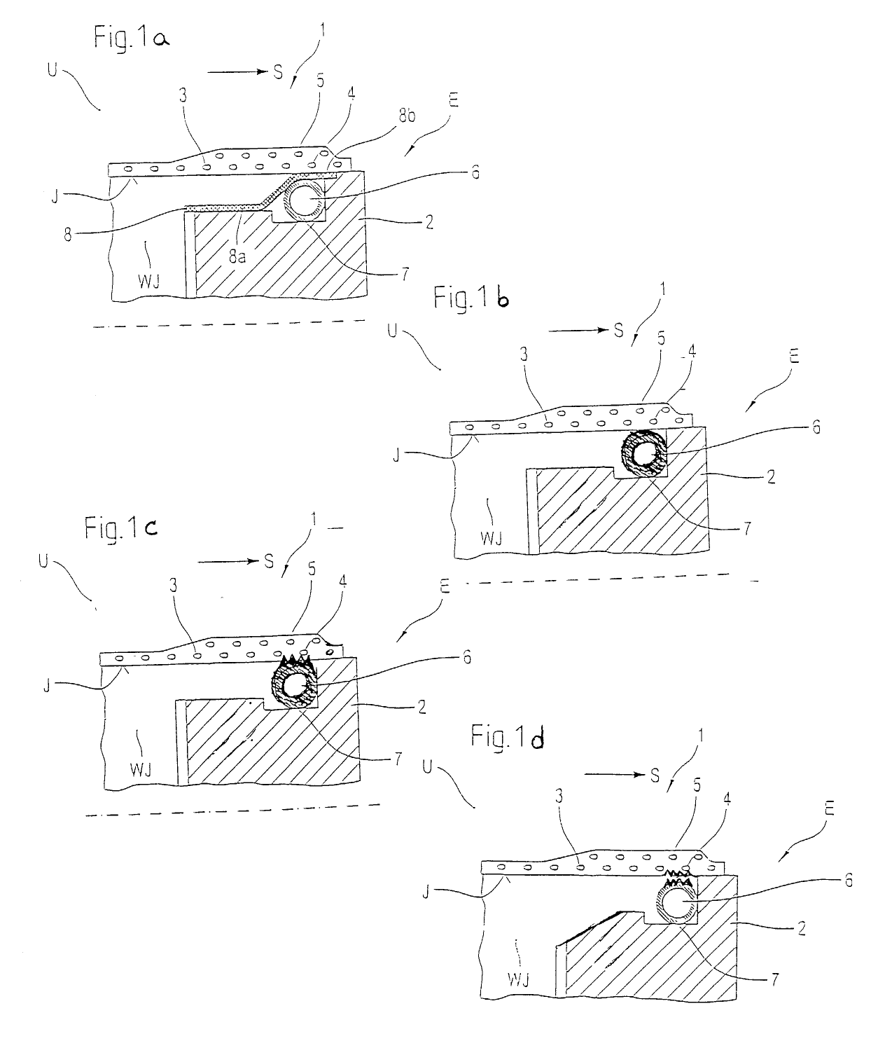

FIG. 1a illustrates an exemplary embodiment of a quick-acting closure or a quick-acting connection, that is to say the fixing of an end region E of the press cover of a shoe press roll 1 to its rotatable end supporting disc 2.

Press cover 3 is provided in a conventional way with reinforcements 4, such that reinforcement in at least one end region of press cover 3 are strengthened, as compared with the central region of the roll, by reinforcing inlays 5.

As a result, end regions E are even more suitable than in previously known press covers to be fitted to rotatable end discs 2 (also referred to as “end covers” or “side plates”).

The shape of end region E, i.e., its diameter, changes only insignificantly as a result of when the radial forces are applied. A conventional or only singly reinforced end region would otherwise widen in an undesired manner. This is achieved, inter alia, by an increased modulus of elasticity of end region E. For example, the modulus of elasticity of the cover in the circumferential direction should therefore be E≧45 N/mm², preferably E≧70 N/mm², in particular E≧90 N/mm².

Reinforcement 5, including the modulus of elasticity, is one such as is described in, e.g., German Patent Application No. DE 101 38 526.9, published subsequently, for which reason further explanations relating to reinforcement 5 will not be discussed further here.

FIG. 1a additionally reveals that, between end region E of press cover 3 and supporting disc 5 there is arranged an element that presses radially with a pressing force that can be varied.

In the exemplary embodiment illustrated in FIG. 1a, at least one inflatable pressure hose 6 is provided as a radially pressing element. Pressure hose 6 is located within an outwardly open (circumferential) groove 7 in supporting disc 2. Further, pressure hose 6 is arranged in groove 7 in order to rotate with (i.e., not relative to) supporting disc 2.

Since press cover 3 is pushed axially onto the shoe press roll during assembly, it is particularly advantageous here that the outer diameter of hose 6 becomes smaller when the hose pressure is reduced.

As a result, the necessary play in order to make assembly and disassembly easier is produced between press cover 3, that is to say in end region E, and supporting disc 2.

FIG. 1a additionally shows a hose strap 8, which covers hose 6 and therefore also reduces possible colliding edges. As a result, the device can act like a shoe horn, which, of course, makes it substantially easier to pull press cover 3 on.

FIGS. 1b-1d illustrate alternative arrangements to the exemplary embodiment depicted in FIG. 1a. In particular, FIG. 1b is substantially similar to the embodiment depicted in FIG. 1a, except that belt 8 has been dispensed with. Thus, while this embodiment will simpler to construct and less expensive regarding due to the fewer number of elements and the simpler arrangement of elements, this embodiment lacks the advantageous shoe horn feature of belt 8.

In the embodiment depicted in FIG. 1c, press cover 3 and hose 6 are connected together, e.g., form fit, adhered, or welded.

Moreover, in the embodiment depicted in FIG. 1d, press cover 3 and hose 6 include a gear-tooth system to detachably connect these elements together. Moreover, while this embodiment does not include belt 8 depicted in FIG. 1a, supporting disc 2 is provided with an inclined portion to facilitate entry of support disc 2 into press cover 3 and hose 6. Further, it is conceivable that the inclined portion could be utilized in the embodiments without belt 8.

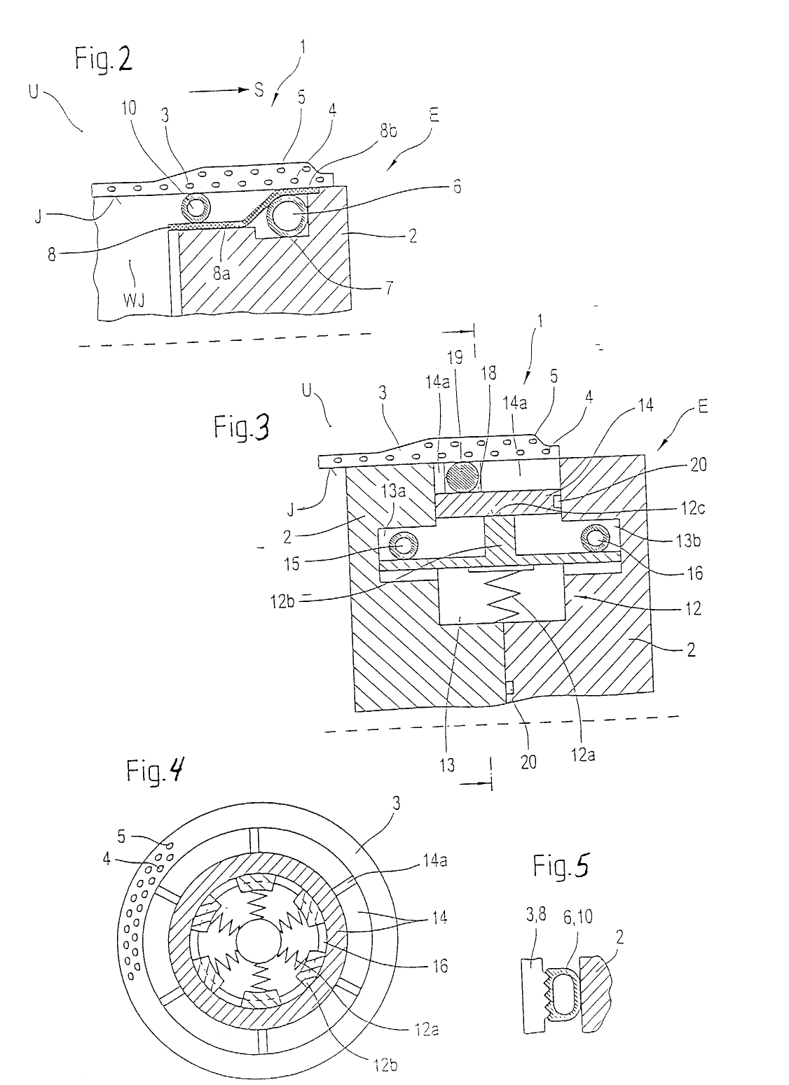

In the embodiment depicted in FIG. 2, which includes the above-discussed features in FIG. 1a, such that common reference numerals are repeated in this Figure, and, in the axial direction beside (e.g., axially inside) hose 6, also includes a second hose 10 which is inflatable, i.e., pressurizable. Hose 10 faces the roll interior WJ and, as stated, is arranged in the axial direction in relation to hose 6 which faces the roll end and likewise is engaged around end supporting disc 2. As a result of this arrangement, both hoses can function in a very expedient manner as a double seal. In addition, it can be seen that hose 10 facing the roll interior is located with its outer surface between the inner wall J of press cover 3 and the outer surface of hose strap 8, whereas pressure hose 6 facing the roll end is located with its outer surface between the inner surface of hose strap 8 and the base of holding groove 7 in supporting disc 2.

Hose strap 8, as viewed in the sliding direction of press cover 3 (during assembly, as arrow S shows), has a first region 8a with a smaller diameter and a second region 8b with a larger diameter. In this case, first region 8a covers the end of disc 2, pointing towards roll interior WJ. Second region 8b covers pressure hose 6.

In the embodiment shown, hose strap 8 is a single part which is slipped on and, on its outer end, is connected to end supporting disc 2. However, it is also conceivable to connect strap 8 simultaneously to one of the two or else to both pressure hoses 6 and 10.

Inner wall J of end region E of press cover 3 in the region of hose 10 and/or the outer surface of hose strap 8 in the region of hose 6 and, as a complementary matching piece to this, the outer surfaces of the aforesaid hoses, can be provided with profiling, as shown in FIG. 5.

For example, the profiling can be formed as depressions matched to the diameter of the pressure hoses provided in hose strap 8 and/or press cover 3. However, the profiling can also be designed, as illustrated in FIG. 5, such that the fluting is machined in the manner of a sawtooth in both the hose or hoses 6, 10 and in hose strap 8 and/or press cover 3. In addition, fluting with a circular or polygonal cross section is possible. The inter-engaging profiling can be present in the circumferential direction of the press cover and/or also transversely with respect to the circumferential direction. As a result, when pressure hose or pressure hoses 6, 10 are inflated, there is also a form fit in addition to the existing frictional fit. This substantially increases the axial retention of press cover 3 and the rotational and also operational safety during the transmission of force from press cover 3 to supporting disc 2.

FIG. 3 shows another embodiment of the radial pressing in accordance with the invention. In this embodiment, firm clamping of press cover 3 to end supporting disc 2 is achieved. Moreover, the pressing element provided is at least one piston-spring unit 12 comprising spring 12a, piston 12b and a piston pressing surface 12c. This unit 12 is mounted in a circumferential outwardly open recess 13 in end disc 2.

As can be seen in FIG. 3, recess 13 has on each side a widening 13a and 13b to hold a relief hose 15 and 16, respectively, which is arranged to counteract the force of spring 12a in such a way that, when hoses 15 and 16 have pressure applied to them, press cover 3 can be released from end disc 2.

As contrast to the embodiment depicted in FIG. 2, compressed air for the pressure hoses needs to be applied in the FIG. 3 embodiment when release of the connection is desired. Although the connection according to FIG. 2 can be produced more simply in technical terms, it requires additional energy to produce the radial force, since the air pressure must be applied during the entire operating state.

As FIG. 3 shows, piston 12b of piston-spring unit 12 is matched to the diameter and the width of recess 13 by a T-shaped cross section.

As FIG. 4 reveals, six springs 12a and six pistons 12b are provided. However, depending on the diameter of the shoe press roll, there would also need to be, for example, only three piston-spring units, in order to be able to arrange them in the manner of a segment or star around the base of recess 13.

A seal carrier 14 that can be acted on by piston-spring unit 12 can press against inner wall J of end region E of press cover 3 when spring 12a is in the clamping state.

On its outer circumference (see FIG. 3), seal carrier 14 is provided with cuts 14a running radially in the circumferential direction (see FIG. 4). As a result, seal carrier 14 can be widened slightly radially. This can be achieved since cuts 14a reach at most as far as groove base 18. This configuration improves the sealing action.

However, in the embodiment of FIG. 3, the actual sealing is achieved by a sealing element 19, which is held in an outwardly open groove 18 that extends in the circumferential direction of cylindrical seal carrier 14. Sealing element 19 can be, for example, an O-ring, as it is known, or a ring with a square cross section or else a sealing cord, sealing pad or the like.

The height dimension of groove 18 is, in the depicted embodiment, chosen to be smaller than the dimension of the diameter of sealing element 19.

A further seal 20 is located in seal carrier 14 in order to seal off the interior of the shoe roll. It should be added that supporting disc 2 can be designed in two parts for assembly purposes, and that, between these two parts, a further seal 20′ can be positioned for the aforesaid reasons.

It is noted that the foregoing examples have been provided merely for the purpose of explanation and are in no way to be construed as limiting of the present invention. While the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed:

1. A shoe roll for dewatering or calendering a moving fibrous web comprising:
a flexible, replaceable press cover having two end regions;
at least one end supporting disc;
at least one of said two end regions having reinforcing inlays and being releasably coupled to said at least one end supporting disc; and
a quick-acting closure, located between an inner wall of said at least one end region and said at least one end supporting disc, comprising a radially pressing element structured to exert a pressing force and to simultaneously seal an interior of said shoe roll from an external environment.

2. The shoe roll in accordance with claim 1, wherein the fibrous web comprises one of a paper and a board web.

3. The shoe roll in accordance with claim 1, wherein the pressing force exerted by said radially pressing element is variable.

4. The shoe roll in accordance with claim 1, wherein said at least one supporting disc comprises a circumferential groove and said radially pressing element comprises at least one inflatable pressure hose arranged within said groove.

5. The shoe roll in accordance with claim 4, wherein said at least one inflatable pressure hose is positioned such that inflating said pressure hose firmly clamps said at least one end region in a sealing manner with said at least one supporting disc and deflating said inflatable pressure hose at least one of loosens and releases said end region from said at least one supporting disc.

6. The shoe roll in accordance with claim 4, further comprising a hose strap arranged in a region of said at least one supporting disc that holds said inflatable pressure hose.

7. The shoe roll in accordance with claim 6, further comprising a second pressure hose arranged beside said inflatable pressure hose in an axial direction around said at least one supporting disc.

8. The shoe roll in accordance with claim 7, wherein said inflatable pressure hose is arranged axially outside of said second pressure hose and is located between an inner surface of said hose strap and said groove, and said second pressure hose is located between an outer surface of said hose strap and an inner wall of said end region.

9. The shoe roll in accordance with claim 8, wherein said hose strap comprises a first region having a first diameter and a second region having a second diameter, in which said first diameter is smaller than said first diameter, and said first region is arranged to cover an end of said supporting disc and said second region is arranged to cover said inflatable pressure hose.

10. The shoe roll in accordance with claim 8, wherein said hose strap is connected to at least one of said at least one supporting disc and at least one of said inflatable pressure hose and said second pressure hose.

11. The shoe roll in accordance with claim 8, wherein said hose strap is pushed onto said at least one supporting disc.

12. The shoe roll in accordance with claim 8, wherein said inflatable pressure hose forms a unit with said press cover.

13. The shoe roll in accordance with claim 8, wherein said inner wall of said end region is structured such that, when at least one of said inflatable pressure hose and said second pressure hose is inflated, a form fit occurs between said at least one of said inflatable pressure hose and said second pressure hose and said inner wall as well as a frictional fit.

14. The shoe roll in accordance with claim 4, wherein an inner wall of said end region is structured such that, when said at least one inflatable pressure hose is inflated, a form fit occurs between said at least one inflatable pressure hose and said inner wall as well as a frictional fit.

15. The shoe roll in accordance with claim 4, wherein said at least one inflatable pressure hose adheres to an inner wall of said end region.

16. The shoe roll in accordance with claim 15, wherein said at least one inflatable pressure hose is welded to the inner wall of the said end region.

17. The shoe roll in accordance with claim 1, wherein said radially pressing element comprises at least one piston-spring unit including a spring and a piston, and a seal carrier arranged to carry at least one seal between a clamping state, in which said at least one seal is pressed against an inner wall of said end region, and an unclamping state, in which said at least one seal is moved out of contact with said inner wall to release said at least one end region from said at least one supporting disc.

18. The shoe roll in accordance with claim 17, wherein said at least one piston-spring unit is arranged to move said seal carrier between said clamping and unclamping states.

19. The shoe roll in accordance with claim 17, wherein said at least one supporting disc comprises a circumferential outwardly open recess, and said piston-spring unit is located in said open recess.

20. The shoe roll in accordance with claim 19, wherein said open recess has a widening on each side to hold inflatable hoses, which are arranged to counteract a force of said spring, such that, when pressure is applied to said hoses, said at least one end region is loosened or released from said supporting disc.

21. The shoe roll in accordance with claim 17, wherein said piston comprises an at least two-part, cylindrical part having a T-shaped cross section and pressing surfaces matched to a diameter and a width of said open recess.

22. The shoe roll in accordance with claim 21, wherein at least three piston-spring units with curved pressing surfaces matched to the diameter and the width of said open recess are arranged in the manner of segments around the base of said open recess.

23. The shoe roll in accordance with claim 22, wherein said at least three piston-spring units comprises six piston-spring units.

24. The shoe roll in accordance with claim 17, wherein said seal carrier has cuts on an outer circumference that extend radially in a circumferential direction.

25. The shoe roll in accordance with claim 24, wherein said seal carrier comprises an outwardly open groove arranged to hold a sealing element.

26. The shoe roll in accordance with claim 25, wherein a height dimension of said outwardly open groove is less than a height of said sealing element.

27. The shoe roll in accordance with claim 1, wherein a modulus of elasticity of said cover in a circumferential direction is greater than or equal to 45 N/mm².

28. The shoe roll in accordance with claim 27, wherein the modulus of elasticity is greater than or equal to 70 N/mm².

29. The shoe roll in accordance with claim 27, wherein the modulus of elasticity is greater than or equal to 90 N/mm².

30. A quick-acting closure for a shoe roll for dewatering or calendering a moving fibrous web that includes a flexible, replaceable press cover having two axial end regions, reinforcing inlays provided in at least one of said two axial end regions, and at least one supporting disc positionable in the at least one end region, said quick-acting closure comprising:
a radially pressing element structured to exert a pressing force and to simultaneously seal an interior of said shoe roll from an external environment; and
said radially pressing element being located between an inner wall of said at least one end region and said at least one end supporting disc.

31. The quick-acting closure in accordance with claim 30, wherein said at least one supporting disc comprises a circumferential groove and said radially pressing element comprises at least one inflatable pressure hose arranged within said groove, and
wherein said at least one inflatable pressure hose is positioned such that inflating said pressure hose firmly clamps said at least one end region in a sealing manner with said at least one supporting disc and deflating said inflatable pressure hose at least one of loosens and releases said end region from said at least one supporting disc.

32. The quick-acting closure in accordance with claim 30, wherein said radially pressing element comprises at least one piston-spring unit including a spring and a piston, and a seal carrier arranged to carry at least one seal between a clamping state, in which said at least one seal is pressed against an inner wall of said end region, and an unclamping state, in which said at least one seal is moved out of contact with said inner wall to release said at least one end region from said at least one supporting disc.

33. The quick-acting closure in accordance with claim 30, wherein said at least one supporting disc comprises a circumferential outwardly open recess, and said piston-spring unit is located in said open recess, and
wherein said open recess has a widening on each side to hold inflatable hoses, which are arranged to counteract a force of said spring, such that, when pressure is applied to said hoses, said at least one end region is loosened or released from said supporting disc.

34. The quick-acting closure in accordance with claim 30, wherein at least three piston-spring units with curved pressing surfaces matched to the diameter and the width of said open recess are arranged in the manner of segments around the base of said open recess,
wherein said seal carrier has cuts on an outer circumference that extend radially in a circumferential direction, and said seal carrier comprises an outwardly open groove arranged to hold a sealing element, and
wherein a height dimension of said outwardly open groove is less than a height of said sealing element.

35. The quick-acting closure in accordance with claim 30, wherein a modulus of elasticity of said cover in a circumferential direction is greater than or equal to 45 N/mm².

36. The quick-acting closure in accordance with claim 35, wherein the modulus of elasticity is greater than or equal to 70 N/mm².

37. The quick-acting closure in accordance with claim 35, wherein the modulus of elasticity is greater than or equal to 90 N/mm².

38. A process of connecting and disconnecting the press cover of the shoe roll in accordance with claim 1, said process comprising:
axially moving at least one end of the at least one press cover onto the at least one supporting disc, whereby the at least one supporting disc radially opens the at least one end.

39. The process in accordance with claim 38, wherein the at least one supporting disc comprises a circumferential groove and the radially pressing element comprises at least one inflatable pressure hose, and said process further comprises:
prior to axially moving at least one end onto the at least one supporting disc, placing the at least one inflatable pressure hose into the groove; and
after the at least one end is moved onto the at least one supporting disc, inflating the at least one inflatable pressure hose against an inner surface of the at least one press cover.

40. The process in accordance with claim 39, wherein, after the at least one inflatable pressure hose is placed in the groove, but prior to axially moving the at least one end onto the at least one supporting disc, said process further comprises placing a belt over the at least one inflatable pressure hose, such that the belt acts as a shoe horn to assist in radially opening the at least one end.

41. The process in accordance with claim 39, wherein, after the at least one inflatable pressure hose is placed in the groove, but prior to axially moving the at least one end onto the at least one supporting disc, and said process further comprises:
placing a belt over the at least one inflatable pressure hose;
positioning a second inflatable pressure hose adjacent the first inflatable pressure hose and over the belt; and
inflating the second inflatable pressure hose to further clamp the at least one end onto the at least one supporting disc.

42. The process in accordance with claim 41, wherein the second inflatable pressure hose is positioned axially inside of the at least one inflatable pressure hose.

43. The process in accordance with claim 39, wherein the at least one inflatable pressure hose and an inner surface of the at least one end are provided with inter-meshable ridges, such that, after inflating the at least one inflatable pressure hose, the inter-meshable ridges inter-mesh.

44. The process in accordance with claim 38, wherein the at least one supporting disc comprises a circumferential groove and the radially pressing element comprises at least one inflatable pressure hose, and said process further comprises:
prior to axially moving at least one end onto the at least one supporting disc, attaching the at least one inflatable pressure hose to the at least one end, such that, after the at least one end is moved onto the at least one supporting disc, the at least one inflatable pressure hose is positioned the groove; and
after the at least one end is moved onto the at least one supporting disc, inflating the at least one inflatable pressure hose to clamp the at least one end to the at least one press cover.

45. The process in accordance with claim 44, wherein the at least one inflatable pressure hose is attached by one of form fitting, welding, adhering.

46. The process in accordance with claim 38, wherein said connecting and disconnecting process is performed using the same assembly devices at each end of the shoe roll.

47. The process in accordance with claim 38, wherein the at least one supporting disc includes an inclined leading edge formed to assist in radially opening the at least one end.
